(19) United States
(12) Patent Application Publication
(10) Pub. No.: US 2024/0328887 A1
(43) Pub. Date: Oct. 3, 2024

(54) SYSTEM AND METHOD TO MECHANICAL SEAL CONDITION MONITORING AND EARLY FAILURE DETECTION

(71) Applicant: Saudi Arabian Oil Company, Dhahran (SA)

(72) Inventors: Keith William Brashler, Dhahran (SA); Ali Al Shehri, Thuwal (SA); Mohammad Al-Ba’adani, Jeddah (SA)

(21) Appl. No.: 18/192,135

(22) Filed: Mar. 29, 2023

(51) Int. Cl. G01M 3/24; G08B 21/18; F04D 15/00

(52) U.S. Cl. CPC G01M 3/24; G08B 21/187; F04D 15/0088

(57) ABSTRACT

A system includes an assembly configured to pump fluid, the assembly comprising: a rotating shaft disposed within a central void where fluid is being pumped; a gland plate enclosing the central void and surrounding the rotating shaft; a contact seal wrapped around the rotating shaft, the contact seal comprising a rotating seal face and a stationary seal face, wherein the rotating seal face is attached to the rotating shaft, and wherein the stationary seal face is mounted on the gland plate; and a patch of sensors imbedded in the gland plate and configured to measure one or more physical parameters of the contact seal during operation; and a controller in communication with the patch of sensors and configured to receive, from the patch of sensors, the one or more physical parameters of the contact seal so that the contact seal is monitored in real-time.

### TECHNICAL FIELD

This disclosure generally relates to condition monitoring of mechanical seals used in oil and gas exploration.

### BACKGROUND

Mechanical seals are a major component of rotating machinery, and function to prevent leakage of the product to atmosphere. The mechanical seal is used on many different types of rotating equipment, including pumps, compressors, mixers, etc. There are various types of mechanical seal arrangements, such as a single seal or a double seal. Further, the mechanical seal support systems also vary in complexity, and can utilize more elaborate systems such as additional cooling, buffer fluids, back up seals, etc.

### SUMMARY

In one aspect, some implementations provide a system that includes: an assembly configured to pump fluid, the assembly comprising: a rotating shaft disposed within a central void of the assembly where fluid is being pumped; a gland plate enclosing the central void and surrounding a section of the rotating shaft; a contact seal wrapped around the rotating shaft and configured to prevent leakage of the fluid being extracted, the contact seal comprising a rotating seal face and a stationary seal face, wherein the rotating seal face is attached to the rotating shaft, and wherein the stationary seal face is mounted on the gland plate; and a patch of sensors imbedded in the gland plate and configured to measure one or more physical parameters of the contact seal during operation when the assembly is pumping fluid; and a controller in communication with the patch of sensors and configured to receive, from the patch of sensors, a stream of data encoding the one or more physical parameters of the contact seal so that the contact seal is monitored in real-time.

The implementations may include one or more of the following features.

The patch of sensors may be closer to the central void than an outer perimeter of the gland plate. The patch of sensors may be positioned in direct contact with the stationary seal face. The patch of sensors may include a vibration sensor comprising a polymer substrate, and a resonant layer comprising an electrically conductive nanomaterial and disposed on a surface of the substrate; and wherein the resonant layer and is configured to generate a resonant response in response to receiving a radio frequency signal from the controller. The patch of sensors may further include a temperature sensor configured to measure an operating temperature of the contact seal. The controller may include: one or more processors; a user-interactive interface coupled to the one or more processors; a non-transitory computer readable medium storing instructions executable by the one or more processors to perform operations comprising: receiving, from the patch of sensors, the stream of data that encode the one or more physical parameters of the contact seal, wherein the one or more physical parameters include the resonant response; determining, based on at least in part, the resonant response, a current vibrational strain at the contact seal; and generating, on the user-interactive interface, a rolling display that includes the current vibrational strain. The operations may further include: comparing the current vibrational strain with a plurality of vibrational strain signatures; and determining whether the current vibrational strain matches at least one of the plurality of vibrational strain signatures that corresponds to a failure condition. The operations may further include: in response to determining that the current vibrational strain matches at least one of the plurality of vibrational strain signatures that corresponds to a failure condition, generating, on the user-interactive interface, an alert on the user-interactive interface. The alert may include a visual alert, and an audio alert. The user-interactive interface is configured to receive user input based on which the one or more processors can adjust the radio frequency signal. The rotating seal face and the stationary seal face each comprises an O-ring.

In another aspect, implementations may provide a computer-implemented method that includes: operating an assembly to pump fluid, wherein the assembly comprises a rotating shaft disposed within a central void of the assembly where fluid is being pumped; a gland plate enclosing the central void and surrounding a section of the rotating shaft; and a contact seal wrapped around the rotating shaft and configured to prevent leakage of the fluid being extracted, the contact seal comprising a rotating seal face and a stationary seal face, wherein the rotating seal face is attached to the rotating shaft, and wherein the stationary seal face is mounted on the gland plate; receiving, from a patch of sensors imbedded in the gland plate, a stream of data encoding one or more physical parameters of the contact seal during operation when the assembly is pumping fluid; and monitoring, based on, at least in part, the stream of data, the contact seal in real-time. The patch of sensors may be closer to the central void than an outer perimeter of the gland plate. The patch of sensors may include: a vibration sensor comprising a polymer substrate, and a resonant layer comprising an electrically conductive nanomaterial and disposed on a surface of the substrate; and wherein the resonant layer and is configured to generate a resonant response in response to receiving a radio frequency signal from a controller. The patch of sensors may further include a temperature sensor configured to measure an operating temperature of the contact seal. The method may further include: receiving, from the patch of sensors, the stream of data that encode the one or more physical parameters of the contact seal, wherein the one or more physical parameters include the resonant response; determining, based on at least in part, the resonant response, a current vibrational strain at the contact seal; and generating, on a user-interactive interface, a rolling display that includes the current vibrational strain. The method may further include: comparing the current vibrational strain with a plurality of vibrational strain signatures; and determining whether the current vibrational strain matches at least one of the plurality of vibrational strain signatures that corresponds to a failure condition. The method may further include: in response to determining that the current vibrational strain matches at least one of the plurality of vibrational strain signatures that corresponds to a failure condition, generating, on the user-interactive interface, an alert on the user-interactive interface. The alert may include a visual alert, and an audio alert. The method may further include: receiving, from the user-interactive interface, user input defining an adjustment to the radio frequency signal; and executing the adjustment to the radio frequency signal.

Implementations according to the present disclosure may be realized in computer implemented methods, hardware computing systems, and tangible computer readable media. For example, a system of one or more computers can be configured to perform particular actions by virtue of having software, firmware, hardware, or a combination of them installed on the system that in operation causes or cause the system to perform the actions. One or more computer programs can be configured to perform particular actions by virtue of including instructions that, when executed by data processing apparatus, cause the apparatus to perform the actions.

The details of one or more implementations of the subject matter of this specification are set forth in the description, the claims, and the accompanying drawings. Other features, aspects, and advantages of the subject matter will become apparent from the description, the claims, and the accompanying drawings.

### DESCRIPTION OF DRAWINGS

FIG. 1 is a diagram illustrating an example of imbedding sensors on a single mechanical seal for condition monitoring and early failure detection according to some implementations of the present disclosure.

FIG. 2A is a diagram with a zoomed view of sensor placement as used in some implementations of the present disclosure.

FIG. 2B shows an example of a controller as used in some implementations of the present disclosure.

FIG. 3 is a flow chart illustrating an example according to some implementations of the present disclosure.

FIG. 4 is a block diagram illustrating an example of a computer system used to provide computational functionalities associated with described algorithms, methods, functions, processes, flows, and procedures, according to an implementation of the present disclosure.

Like reference numbers and designations in the various drawings indicate like elements.

### DETAILED DESCRIPTION

The disclosed technology is directed to system and method condition monitoring and early failure detection of mechanical seals on generally available on various pumps and compressors. Mechanical seals or shaft seals for rotating equipment constitute a significant component to insure both the reliability and the availability of rotating equipment such as centrifugal pumps and compressors. Two main components of a mechanical seal include a dynamic sealing face and a stationary sealing face (together known as the sealing faces). Although other sealing points may also prevent leakage to the atmosphere, the sealing faces are the primary sealing mechanism to prevent the fluid leakage. The dynamic sealing face is fixed to the shaft and can rotate (e.g., along with the rotating shaft and hence known as dynamic). The other component is known as the stationary sealing face, which is fixed in, e.g., the gland plate and is stationary. The mechanical seal is often deemed the weak link on equipment that involves a rotating shaft because, as a component, the mechanical seal is prone to wear and tear, which can lead to failure over time. For example, the mechanical seal generally operates under conditions of high pressure, high temperature, high speed, and abrasive environment, all of which can cause the seal to wear and degrade over time. In one illustrative example, the mechanical seal operates to prevent leakage of fluids that are very close to the vapor pressure and have a tendency to flash when released to atmosphere. When the seal fails, the failure can result in leaks, equipment damage, and safety hazards. For example, leakage of product to the atmosphere in many cases is generally not tolerable, due to safety related concerns with the discharge of hazardous fluids or gases. Moreover, mechanical seal failures can result in high maintenance costs, un-planned downtime, production losses, and in some cases loss or damage of equipment.

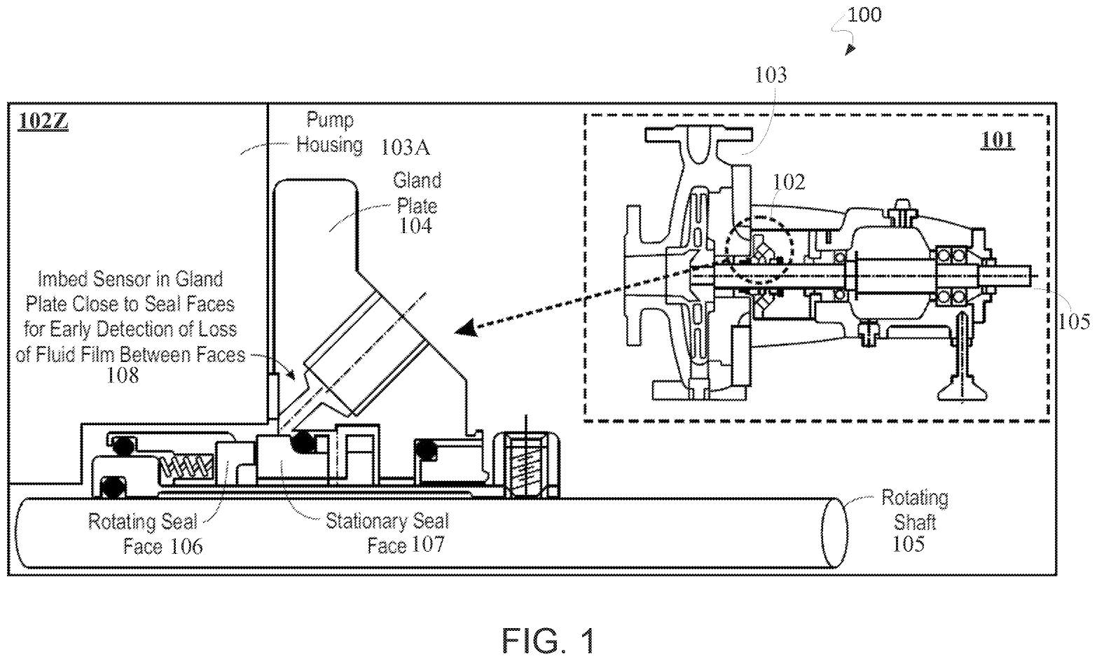

The implementations aims to provide a low-cost solution for early failure detection and troubleshooting of mechanical seal failures by utilizing temperature sensors and vibration sensors to monitor conditions of the mechanical seal. The implementations have a broad-range of applications and are not limited to oil and gas explorations. In some cases, the implementations can utilize nano sensors (e.g., stretchable nano sensors) positioned as close to the sliding seal faces as possible to improve the transmission of the vibration responses from the seal. The implementations can also integrate temperature and possibly Acoustic Emission (AE) sensing to improve the sensitivity of detecting the on-set of unfavorable seal face sliding conditions. In various implementations, the data detected by sensors can be integrated and then analyzed with the aid of machine learning algorithms to streamline the detection of the inception of upset conditions at the mechanical seal faces, thereby further improving the quality of early failure detection. FIGS. 1-4 below provide more details of the various implementations.

As illustrated in diagram 100 of FIG. 1, implementations may position sensors, e.g., radio frequency nano sensors, on a gland plate as close to the sealing faces as possible to potentially optimize the sensitivity for measuring vibration at the mechanical face. Diagram 100 shows an assembly 101 that includes pump 103 and rotating shaft 105. Pump 103 can include a centrifugal pump that operates to perform suction of fluid using, e.g., rotating shaft 105. As illustrated, region 102 has a zoomed view 102Z showing gland plate 104, pump housing 103A, and the mounting position 108 for sensors that monitor conditions of mechanical faces including rotating seal face 106 and stationary seal face 107.

For context, the primary sealing mechanism that can prevent fluid leakage into the atmosphere is known as the “contact seal” or “face seal.” Contact seals can be used in pumps, compressors, and other types of rotating equipment that handle fluids. In a contact seal, two flat surfaces, known as the “seal faces,” are pressed together to create a seal. One seal face is typically stationary, while the other is attached to the rotating shaft (e.g., rotating shaft 105). As the shaft rotates, the seal faces remain in contact with each other, thereby preventing fluid from leaking out of the equipment. The dynamic seal face, which is the seal face attached to the rotating shaft, generally can be more prone to wear and damage than the stationary seal face in a contact seal. This is because the dynamic seal face is in constant contact with the rotating shaft and is subjected to higher levels of friction and wear compared to the stationary seal face. For example, the dynamic seal face can experience a variety of forms of wear and damage, including abrasion, erosion, and thermal damage. Abrasion can occur from the product or pumpage (e.g., the amount of fluid raised by pumping or the work done by pumping) when using the seal. Erosion can occur when fluid flowing through the equipment causes wear on the seal face. Thermal damage can occur when the seal face is exposed to high temperatures, which can cause it to crack or warp. To minimize wear and damage to the dynamic seal face, a material compatible with the fluid is often used for the seal. What is more, regular replacement of worn or damaged seal faces can be effective to prevent leaks and equipment damage.

Various implementations pursue judicious placement of sensors on the rotating assembly to monitor, in-situ, both the dynamic and stationary seal faces to achieve effective sealing and prevent fluid leakage. As illustrated, the positioning of imbedding sensors can be on the gland plate 104 and as close to seal faces as possible to achieve early detection of loss of fluid film between rotating seal face 106 and stationary seal face 107. The implementations may include a gland plate or gland follower (e.g., gland plate 104) in conjunction with the mechanical seal (e.g., including rotating seal face 106 and stationary seal face 107).

Gland plate 104 is a stationary component, which can be made from a metal plate or casting. As illustrated, gland plate 104 is located on the housing or casing of the equipment (e.g., pump housing 103A). Here, gland plate 104 can be bolted or otherwise attached to pump housing 103A. Gland plate 104 has a central opening through which the rotating shaft 105 passes, and the mechanical seal (e.g., including rotating seal face 106 and stationary seal face 107) is located within this opening. Gland plate 104 may be designed to hold the mechanical seal in place and provide a secure seal around the rotating shaft 105 so as to prevent fluid from leaking out of the equipment. Gland plate 104 may have grooves or channels to direct fluid away from the seal and prevent the fluid from entering the housing or casing.

Sensors may be mounted on gland plate 104 and placed in close proximity to rotating seal face 106 and stationary seal face 107. The exact positioning location can be mechanical seal design specific, and therefore, dependent on available gland plate space. However, the affinity of placement can allow the sensors to perform in-situ monitoring of the condition of the mechanical seal (e.g., including rotating seal face 106 and stationary seal face 107) in real-time and as the assembly 101 is operating (i.e., without disruption of production).

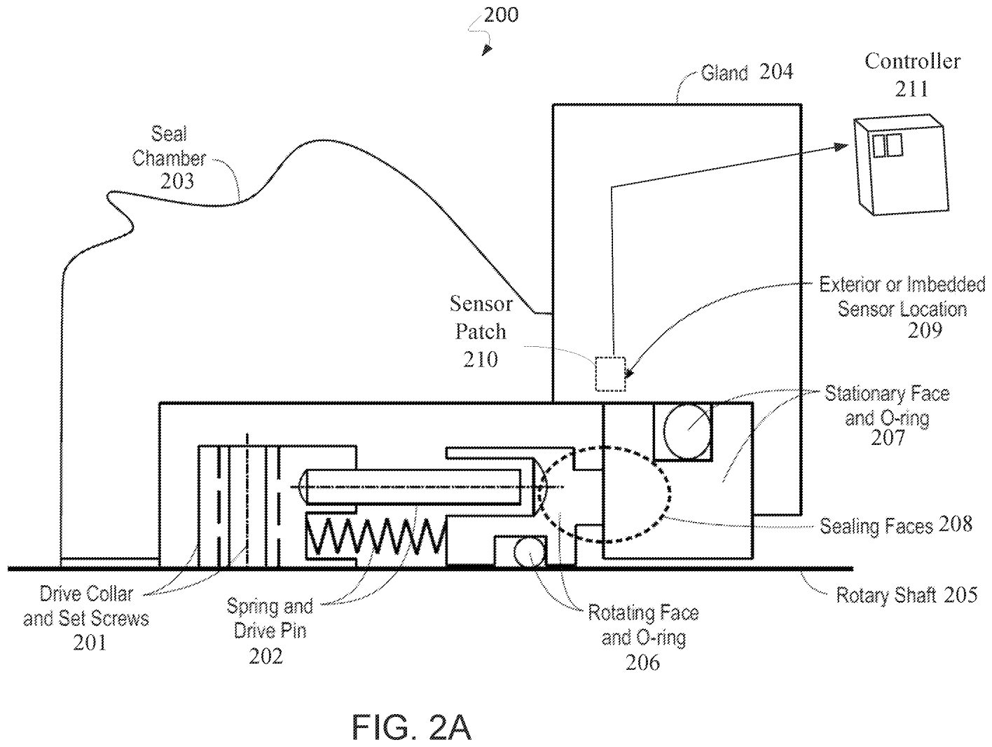

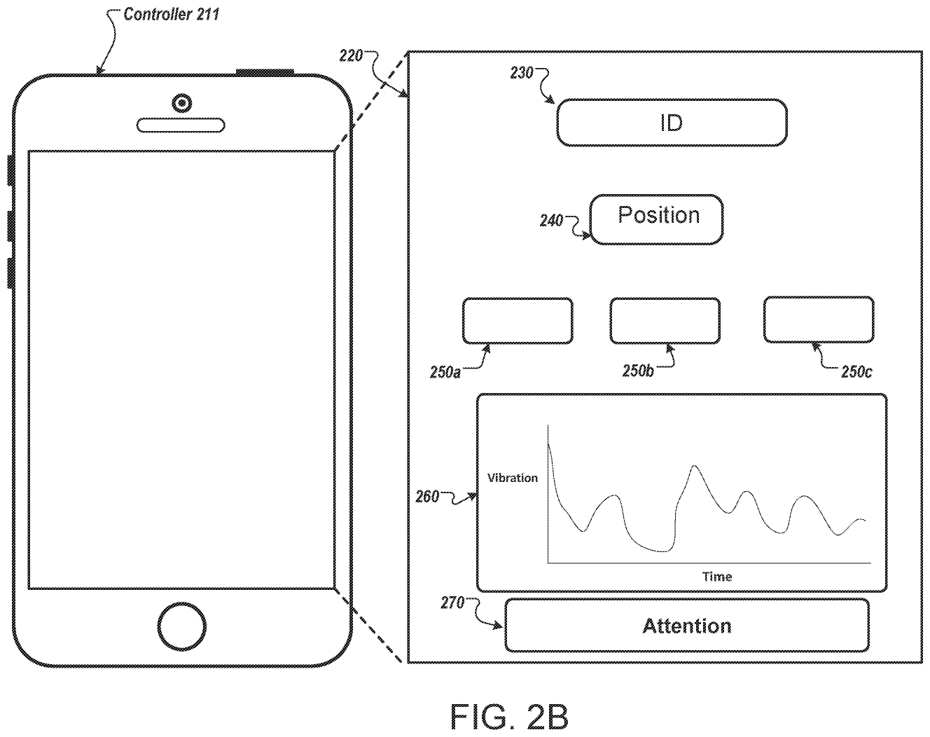

Further referring to FIG. 2A, the positioning of the sensor can be further illustrated with a zoomed cross-sectional view 200 showing seal chamber 203 with a mechanical seal that includes rotating face with O-ring 206 and stationary face with O-ring 207. Sealing faces 208 are thus formed with rotating face with O-ring 206 and stationary face with O-ring 207 pressed against each other. As illustrated, sealing faces 208 are driven by spring and driver pin 202, which are mounted in the seal chamber 203 using driver collar and set screws 204. In some mechanical seals, an O-ring is used to provide a secondary sealing mechanism to further reduce the likelihood of fluid leakage around the stationary and dynamic seal faces. The O-ring can be made from an elastomeric material, such as Buna-N or Viton, both compatible with the fluid being sealed and can withstand the operating conditions of the equipment. The O-ring can be installed in a groove on either the stationary or dynamic seal face, depending on the design of the mechanical seal. When the seal faces 208 are brought together, the O-ring is compressed and forms a tight seal around the shaft 205 to prevent fluid from leaking out of the equipment. The use of an O-ring as a secondary sealing mechanism can help to improve the reliability and effectiveness of the mechanical seal. Notably, however, iot all mechanical seals use O-rings, and somie designs may rely solely on the contact between the seal faces to provide the primary sealing mechanism.

As illustrated, rotating face with O-ring 206 is driven by spring and drive pin 202. In some mechanical seal designs, the dynamic seal face (e.g., rotating face with O-ring 206) is coupled to a spring and driver pin to provide a self-aligning and self-compensating mechanism that can help to improve the sealing performance and reliability. In these designs, the spring can be installed to apply a constant force to the dynamic seal face (e.g., rotating face with O-ring 206) to maintain contact between the seal faces 208 and compensate for potential misalignment or axial movement of the rotating shaft 205. The driver pin can be attached to the rotating shaft 205 and engages with a slot or recess in the dynamic seal face (e.g., rotating face with O-ring 206). As the shaft rotates, the driver pin drives the dynamic seal face (e.g., rotating face with O-ring 206) into a rotational motion, providing a self-cleaning and self-lubricating mechanism that can help to prevent wear and damage to the seal faces 208. Such features can improve the reliability and effectiveness of the mechanical seal, particularly in applications where there may be misalignment or axial movement of the shaft.

As illustrated, the sensors can located exterior to the seal chamber 203 and/or imbedded in gland 204, as illustrated in location 209. For example, the sensors can be placed on the exterior surface of the gland plate 204, or imbedded in the gland plate 204. Notably, the sensors are advantageously placed in close proximity to sealing faces 208. In some cases, the gap is as close as possible, for example, within a few wavelengths of the vibrational wave generated by the sealing faces 208. This can be on the order of a few millimeters. By way of illustration, the sensors can be imbedded into the gland plate as close to the seal faces 208 as possible without effecting the mechanical integrity of the gland plate. In some cases, the gland plate could be drilled through so that a sensor can be imbedded through the void and placed in direct contact with the stationary seal face 207. The affinity can enhance the sensing capabilities for early detection of unfavorable conditions developing in the sealing faces without disturbing the operation of the sealing faces.

The sensors can include a patch of sensors (e.g., sensor patch 210 that houses multiple sensors). For example, a sensor can be based on Radio Frequency (IF) resonance response and constructed using responsive nanomaterials patches (such as silver nanoparticles or carbon nanotubes) for condition monitoring of vertical crude charge pumps, as outlined in U.S. application Ser. No. 17/333,572 (published as US 2022/0.381254), U.S. application Ser. No. 17/333,612 (published as US 2022/0381134), Ser. No. 17/333,597 (published as US 2022/0381704), U.S. Provisional Application No. 63/380,014, and U.S. application Ser. No. 17/984,807, all of which are incorporated herein by reference.

By way of illustration, a sensor can target monitoring mechanical strains such as vibration, stress, and strain. For example, the sensor can operate based on the impact these mechanical perturbations have on the nano effect of electrostatic capacitive molecular coupling in-between carbon nanotube (CNT) polymer composites. Vibration and strain conditions can be correlated to the frequency resonance shift of the resonating structure, and therefore to the health status of the pump assembly. In other words, the sensing mechanism can be described in terms of the surface current distribution on the resonating patches, which is directly related to the resonance and frequency shift.

Some implementations may also incorporate a Niro-Electro Mechanical system-based (MEMS) piezoelectric accelerometer sensor that produces electric charge or output under acceleration, strain, or vibration. Such MEMS sensor can include a high-temperature accelerometer with a temperature range up to 250° C. Piezoelectric and elastomeric composite materials can be utilized to create a sensor stack design enabling effective vibrational transfer and transduction to piezoelectric signals, which can then be filtered and amplified by an external circuit to accurately evaluate the vibration frequencies during operation. Designs can factor in environmental performance requirements of the pumping system so that the frequency responses exhibited by anomalous behaviors can reveal an onset of failure. MEMS sensor configuration can utilize micro machined silicon, thin film deposition, and microfabrication patterning. The main components can include an anchor, a proof mass, a flexible/spring-like membrane, and a piezoelectric material that converts strain or vibrations to voltage as the proof mass flexes the piezoelectric thin film. In this manner, strain loading or vibration can be readily converted to output voltage signals and when coupled to an appropriate amplifier circuit design, the output signal can be designed to produce a sharp resonant peak at very specific frequencies. Using this approach, precision accelerometers have been demonstrated for a wide range of applications. A simpler approach is to utilize thin-film piezoelectric materials fabricated on a flexible substrate.

In various implementations, a change in baseline or response in temperature or acoustic signal can indicate the on-set of seal face distress. One particular signal may be more effective at early detection depending on the failure mechanism. A loss of seal flush may develop high temperature, dry running seal faces resulting in temperature effects and acoustic and vibration signature changes. Prior to seal face failure, the seal face may experience distress from a change in process conditions, loss of seal support such as seal flush, misalignment, vibration. These implementations of the present disclosure can achieve early detection and assist with troubleshooting the failures of the mechanical seal faces.

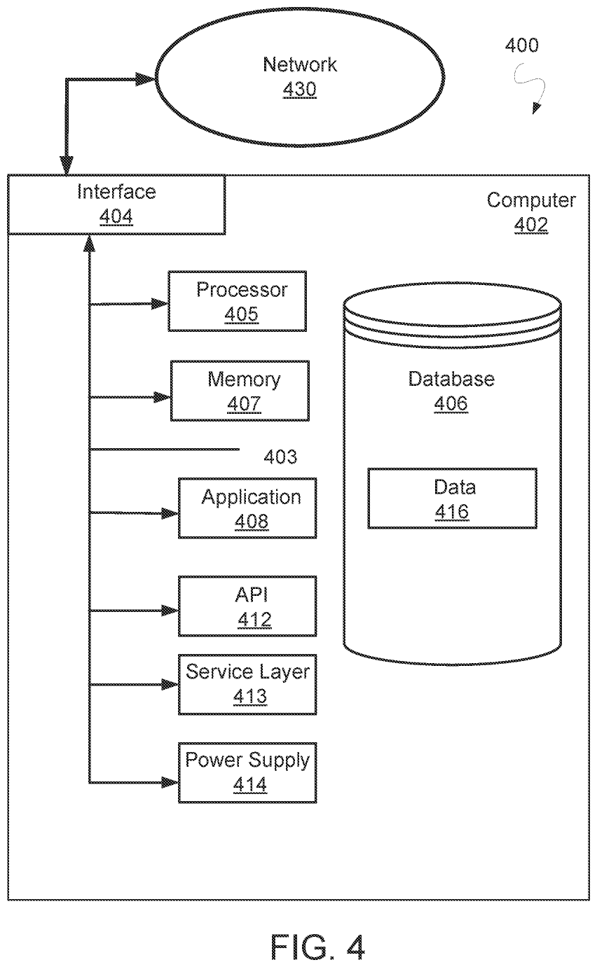

Notably, while all sensor types are available for early detection, some may be more sensitive (or more specific) than others depending on failure mechanism. Additionally, even though one sensor may be better for early detection, other sensors may provide additional or complementary data. By integrating sensors (e.g., vibrational and temperature sensors) in the same patch, data from all sensors can be communicated to controller 211 to facilitate a refined or holistic failure investigation to determine root cause. The communication can be wired or wireless. Examples of controller 211 and communication configurations can be found in FIG. 4 and the associated descriptions. After a mechanical seal has failed and a detailed failure analysis has been performed, the results can be used to as training data to strengthen the machine learning capability, and develop criteria for severity of the condition and Mean Time Between failure (MTBF) rates.

In some cases, anomalous vibration signature can be represented by using the feature subspace extracted for each fault or failure type. In these cases, new fault data can be matched (e.g., by controller 211) to the fingerprint feature subspace of each fault type, and hence can pinpoint the root cause of a failure in the pump. For example, an implementation of recurrent neural network (RNN) and convolutional neural network (CNN) can be developed to address the absence of data from negative classes and has achieved significant improvements in terms of rapid and reliable anomaly detection and failure prediction. In this example, the time-series data of the pump condition can involve temporal dependencies. The current condition data may not only depend on current condition data, but also on past condition data. The RNN approach can capture these condition dependences on the sequential condition patterns that are formed by features of the condition of each timestamp. Long short-term memory (LSTM) architecture can be implemented in the one-class RNN to model the temporal dynamic behavior of the condition and detect anomaly signals.

FIG. 2B shows an example of an example of a user-interactive graphical user interface (GUI) 220 on controller 211. Like the cockpit of an aircraft, or the instrument panel on a vehicle, the interactive GUI 220 presents a panel that allows the user to visualize real-time and in-situ measurements of the mechanical seal of a selected pump assembly (e.g., corresponding to a chosen ID 230) while the pump operates to pump fluid at a position 240. In one illustration, the operating environment is within a downhole of an oil and gas exploration site and the position may refer to a depth range. The panel can allow real-time measurements from various sensors (e.g., measurements 250a, 250b, 250c) on the selected pump assembly to be streamed and projected to the user, e.g., as a rolling curve (such as bar 260), a usage bar, a progress bar, or a speedometer layout. These measured parameters can include temperature, vibration amplitude, and strain. For example, the user-interactive GUI 220 can project trend information and forecast a behavior of a measured parameter (e.g., time left before next maintenance or replacement of a pump component). In this example, the panel may receive measurements, and predict the well-being of the mechanical seal using these measurements and past history. Additionally, the modeling may factor in fluid properties of the environment where the pump assembly is operating. Moreover, the interactive GUI 220 can provide operational guidance or real-time alert (e.g., attention 270) on the panel based on the real-time measurements, much like navigational guidance on a GPS device. The real-time alert can include both visually popping the attention flag, and sounding an alarm on controller 211.

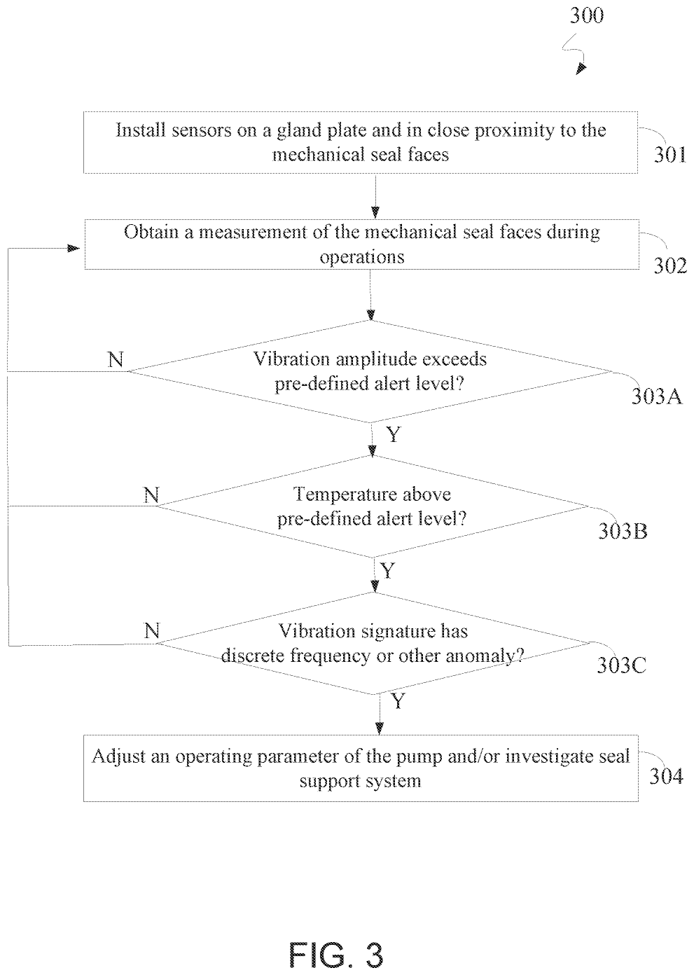

FIG. 3 is a flow chart 300 illustrating an example of a process according to some implementations of the present disclosure. The process may initially install sensors on a gland plate and in close proximity to the mechanical seal faces (301). As explained above in association with FIGS. 1, 2A, and 2B, the gland opening can have a central opening through which a rotating shaft passes. A mechanical seal is provided to prevent the fluid inside the rotating shaft from leaking to the outside. The mechanical seal can have a stationary seal face and a dynamic face that, when pressed against each other, form a closure to prevent leakage. The sensors can be housed in a sensor patch and placed to close proximity to the seal faces. For example, the sensors can be located within 3 millimeters away from the perimeter of the rotating shaft defining the outer boundary of the seal faces. The sensors may include vibrational sensors and temperature sensors. The implementations can incorporate an RF nano sensor mounted on a flexible stretchable substrate with metallic conductive sensing layer patches to detect vibration signals. For example, the nano sensor may utilize the resonating response of the responsive top layer to determine whether the operating equipment is operating at a condition that is within a normal operating range or in a failure/warning mode. The resonant patch can use a nanoscale polymer composite material and can be configured to resonate at a frequency in response to receiving the electromagnetic interrogation pulse from an RF interrogator. For example, the shape and/or dimensions of the resonant patch including the nanoscale polymer composite material can be adjusted, such that the resonant patch resonates at the resonant frequency. The implementations can adjust a thickness of the resonant patch, a length of the resonant patch, and a width of the resonant patch to achieve adjustment of the resonant frequency. The nanoscale polymer composite material can include carbon nanotubes (CNT), silver nanoparticles, or a combination of these materials. The CNT, silver nanoparticles, or both can be disposed on a stretchable polymer substrate. The sensor may be enclosed by, but may not touch, the sensor capsule. Such encapsulation can protect vibration sensor and reduce the exposure from electrical or thermal energy (such as ignition of fluid from heat or sparks), without interfering with the operation of vibration sensor.

The process may then activate the sensors to obtain real-time and in-situ measurements of the seal face conditions (302). In various implementations, the monitoring can be performed while the equipment (e.g., assembly 101 with pump 103) is operating so that no equipment downtime is incurred. The main advantage of the implementations includes a cost-effective solution for real-time and in-situ monitoring to achieve early mechanical seal failure detection. The implementations can include a portable and a permanently mounted device for continuous monitoring of the equipment during active operation (e.g. drilling operation on-site).

The process may then determine whether the mechanical seal faces are functioning without leakage and without abnormal seal face conditions (303A to 303C). For example, the process may determine whether the vibration amplitude, as detected by the vibration sensor, exceeds a pre-defined threshold level (303A). The implementations may compare the temperature with a pre-defined threshold level and determine whether the temperature is above the pre-defined threshold level (303B). The implementations may determine whether the vibration signature contains discrete vibration frequency or other anomaly (303C). As discussed above, implementations may include machine learning and data fusion to differentiate and filter vibration signals by analyzing physical sensors data such as vibration, temperature, and acoustic emission (AlE). In one example, the temperature sensor can measure and trend the recorded temperature to detect a deviation from the baseline temperature. An increase in temperature can be a good indicator that the mechanical seal faces are experiencing upset conditions of a pending mechanical seal failure mode (i.e. dry running, etc.), and this can indicate the on-set of mechanical seal failure. Additional process variables can also be integrated to enhance the machine learning diagnostics and early failure detection capabilities. Depending on the complexity of the mechanical seal design and seal support system, such other process variables can include seal flush temperature and flush rate, pump or compressor operating conditions (i.e. flow rate), mechanical seal chamber pressure, etc. The rather fulsome analysis can thus allow for precise and early detection of incipient mechanical seal face upset conditions, and reduce overall maintenance costs, unplanned down time, production losses, safety and environmental concerns with catastrophic failure of mechanical seals in hazardous and flammable services.

In response to determining that the conditions of blocks 303A, 303B, and 303C are not met, the process may continue to monitor the conditions of the seal faces (302). In response to determining that the conditions are met, the implementations can proceed to adjust an operating parameter of the pump and/or the mechanical support system (304). For example, the process may taper down the drilling operation to reduce the load in the pump. The process may also alert an operator to shut down the pump or initiate an investigation so that components of the mechanical seal can be replaced. While FIG. 3 illustrates examples of conditions, the implementations are not limited to the examples. Nor are the implementations limited to the specific order or the combination illustrated in FIG. 3. For example, the implementations may proceed to adjustment when one of the three conditions is met.

FIG. 4 is a block diagram 400 illustrating an example of a computer system 400 used to provide computational functionalities associated with described algorithms, methods, functions, processes, flows, and procedures, according to an implementation of the present disclosure. The illustrated computer 402 is intended to encompass any computing device such as a server, desktop computer, laptop/notebook computer, wireless data port, smart phone, personal data assistant (PDA), tablet computing device, one or more processors within these devices, another computing device, or a combination of computing devices, including physical or virtual instances of the computing device, or a combination of physical or virtual instances of the computing device. Additionally, the computer 402 can comprise a computer that includes an input device, such as a keypad, keyboard, touch screen, another input device, or a combination of input devices that can accept user information, and an output device that conveys information associated with the operation of the computer 402, including digital data, visual, audio, another type of information, or a combination of types of information, on a graphical-type user interface (UI) (or GUI) or other UI.

The computer 402 can serve in a role in a computer system as a client, network component, a server, a database or another persistency, another role, or a combination of roles for performing the subject matter described in the present disclosure. The illustrated computer 402 is communicably coupled with a network 430. In some implementations, one or more components of the computer 402 can be configured to operate within an environment, including cloud-computing-based, local, global, another environment, or a combination of environments.

The computer 402 is an electronic computing device operable to receive, transmit, process, store, or manage data and information associated with the described subject matter. According to some implementations, the computer 402 can also include or be communicably coupled with a server, including an application server, e-mail server, web server, caching server, streaming data server, another server, or a combination of servers.

The computer 402 can receive requests over network 430 (for example, from a client software application executing on another computer 402) and respond to the received requests by processing the received requests using a software application or a combination of software applications. In addition, requests can also be sent to the computer 402 from internal users, external or third-parties, or other entities, individuals, systems, or computers.

Each of the components of the computer 402 can communicate using a system bus 403. In some implementations, any or all of the components of the computer 402, including hardware, software, or a combination of hardware and software, can interface over the system bus 403 using an application programming interface (API) 412, a service layer 413, or a combination of the API 412 and service layer 413. The API 412 can include specifications for routines, data structures, and object classes. The API 412 can be either computer-language independent or dependent and refer to a complete interface, a single function, or even a set of APIs. The service layer 413 provides software services to the computer 402 or other components (whether illustrated or not) that are communicably coupled to the computer 402. The functionality of the computer 402 can be accessible for all service consumers using this service layer. Software services, such as those provided by the service layer 413, provide reusable, defined functionalities through a defined interface. For example, the interface can be software written in JAVA, C++, another computing language, or a combination of computing languages providing data in extensible markup language (XML) format, another format, or a combination of formats. While illustrated as an integrated component of the computer 402, alternative implementations can illustrate the API 412 or the service layer 413 as stand-alone components in relation to other components of the computer 402 or other components (whether illustrated or not) that are communicably coupled to the computer 402. Moreover, any or all parts of the API 412 or the service layer 413 can be implemented as a child or a sub-module of another software module, enterprise application, or hardware module without departing from the scope of the present disclosure.

The computer 402 includes an interface 404. Although illustrated as a single interface 404 in FIG. 4, two or more interfaces 404 can be used according to particular needs, desires, or particular implementations of the computer 402. The interface 404 is used by the computer 402 for communicating with another computing system (whether illustrated or not) that is communicatively linked to the network 430 in a distributed environment. Generally, the interface 404 is operable to communicate with the network 430 and comprises logic encoded in software, hardware, or a combination of software and hardware. More specifically, the interface 404 can comprise software supporting one or more communication protocols associated with communications such that the network 430 or interface's hardware is operable to communicate physical signals within and outside of the illustrated computer 402.

The computer 402 includes a processor 405. Although illustrated as a single processor 405 in FIG. 4, two or more processors can be used according to particular needs, desires, or particular implementations of the computer 402. Generally, the processor 405 executes instructions and manipulates data to perform the operations of the computer 402 and any algorithms, methods, functions, processes, flows, and procedures as described in the present disclosure.

The computer 402 also includes a database 406 that can hold data for the computer 402, another component communicatively linked to the network 430 (whether illustrated or not), or a combination of the computer 402 and another component. For example, database 406 can be an in-memory, conventional, or another type of database storing data consistent with the present disclosure. In some implementations, database 406 can be a combination of two or more different database types (for example, a hybrid in-memory and conventional database) according to particular needs, desires, or particular implementations of the computer 402 and the described functionality. Although illustrated as a single database 406 in FIG. 4, two or more databases of similar or differing types can be used according to particular needs, desires, or particular implementations of the computer 402 and the described functionality. While database 406 is illustrated as an integral component of the computer 402, in alternative implementations, database 406 can be external to the computer 402. As illustrated, the database 406 holds data 416 including, for example, data from sensors installed near the mechanical seal, as explained in more detail in association with FIGS. 1 and 2A.

The computer 402 also includes a memory 407 that can hold data for the computer 402, another component or components communicatively linked to the network 430 (whether illustrated or not), or a combination of the computer 402 and another component. Memory 407 can store any data consistent with the present disclosure. In some implementations, memory 407 can be a combination of two or more different types of memory (for example, a combination of semiconductor and magnetic storage) according to particular needs, desires, or particular implementations of the computer 402 and the described functionality. Although illustrated as a single memory 407 in FIG. 4, two or more memories 407 or similar or differing types can be used according to particular needs, desires, or particular implementations of the computer 402 and the described functionality. While memory 407 is illustrated as an integral component of the computer 402, in alternative implementations, memory 407 can be external to the computer 402.

The application 408 is an algorithmic software engine providing functionality according to particular needs, desires, or particular implementations of the computer 402, particularly with respect to functionality described in the present disclosure. For example, application 408 can serve as one or more components, modules, or applications. Further, although illustrated as a single application 408, the application 408 can be implemented as multiple applications 408 on the computer 402. In addition, although illustrated as integral to the computer 402, in alternative implementations, the application 408 can be external to the computer 402.

The computer 402 can also include a power supply 414. The power supply 414 can include a rechargeable or non-rechargeable battery that can be configured to be either user- or non-user-replaceable. In some implementations, the power supply 414 can include power-conversion or management circuits (including recharging, standby, or another power management functionality). In some implementations, the power-supply 414 can include a power plug to allow the computer 402 to be plugged into a wall socket or another power source to, for example, power the computer 402 or recharge a rechargeable battery.

There can be any number of computers 402 associated with, or external to, a computer system containing computer 402, each computer 402 communicating over network 430. Further, the term “client,” “user,” or other appropriate terminology can be used interchangeably, as appropriate, without departing from the scope of the present disclosure. Moreover, the present disclosure contemplates that many users can use one computer 402, or that one user can use multiple computers 402.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal, for example, a machine-generated electrical, optical, or electromagnetic signal that is generated to encode information for transmission to a receiver apparatus for execution by a data processing apparatus. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second (s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” or “electronic computer device” (or equivalent as understood by one of ordinary skill in the art) refer to data processing hardware and encompass all kinds of apparatus, devices, and machines for processing data, including by way of example, a programmable processor, a computer, or multiple processors or computers. The apparatus can also be, or further include special purpose logic circuitry, for example, a central processing unit (CPU), an FPGA (field programmable gate array), or an ASIC (application-specific integrated circuit). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with an operating system of some type, for example LINUX, UNIX, WINDOWS, MAC OS, ANDROID, IOS, another operating system, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and apparatus can also be implemented as, special purpose logic circuitry, for example, a CPU, an FPGA, or an ASIC.

Computers for the execution of a computer program can be based on general or special purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device.

Non-transitory computer-readable media for storing computer program instructions and data can include all forms of media and memory devices, magnetic devices, magneto optical disks, and optical memory device. Memory devices include semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Magnetic devices include, for example, tape, cartridges, cassettes, internal/removable disks. Optical memory devices include, for example, digital video disc (DVD), CD-ROM, DVD+/−R, DVD-RAM, DVD-ROM, HD-DVD, and BLURAY, and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special purpose logic circuitry.

To provide for interaction with a user, implementations of the subject matter described in this specification can be implemented on a computer having a display device, for example, a CRT (cathode ray tube), LCD (liquid crystal display), LED (Light Emitting Diode), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity, a multi-touch screen using capacitive or electric sensing, or another type of touchscreen. Other types of devices can be used to interact with the user. For example, feedback provided to the user can be any form of sensory feedback. Input from the user can be received in any form, including acoustic, speech, or tactile input. In addition, a computer can interact with the user by sending documents to and receiving documents from a client computing device that is used by the user.

The term “graphical user interface,” or “GUI,” can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n or 802.20 (or a combination of 802.11x and 802.20 or other protocols consistent with the present disclosure), all or a portion of the Internet, another communication network, or a combination of communication networks. The communication network can communicate with, for example, Internet Protocol (IP) packets, Frame Relay frames, Asynchronous Transfer Mode (ATM) cells, voice, video, data, or other information between networks addresses.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what can be claimed, but rather as descriptions of features that can be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A system comprising:
an assembly operable to pump fluid, the assembly comprising:
a rotating shaft disposed within a central void of the assembly where fluid is being pumped;
a gland plate enclosing the central void and surrounding a section of the rotating shaft;
a contact seal wrapped around the rotating shaft and configured to prevent leakage of the fluid being pumped, the contact seal comprising a rotating seal face and a stationary seal face, wherein the rotating seal face is attached to the rotating shaft, and wherein the stationary seal face is mounted on the gland plate; and
a patch of sensors imbedded in the gland plate and configured to measure one or more physical parameters of the contact seal during operation when the assembly is pumping fluid; and
a controller in communication with the patch of sensors and configured to receive, from the patch of sensors, a stream of data encoding the one or more physical parameters of the contact seal so that the contact seal is monitored in real-time.

2. The system of claim 1, wherein the patch of sensors are closer to the central void than an outer perimeter of the gland plate.

3. The system of claim 1, wherein the patch of sensors are positioned in direct contact with the stationary seal face.

4. The system of claim 1, wherein the patch of sensors comprise a vibration sensor comprising a polymer substrate, and a resonant layer comprising an electrically conductive nanomaterial and disposed on a surface of the substrate; and
wherein the resonant layer and is configured to generate a resonant response in response to receiving a radio frequency signal from the controller.

5. The system of claim 4, wherein the patch of sensors further comprise a temperature sensor configured to measure an operating temperature of the contact seal.

6. The system of claim 4, wherein the controller comprises:
one or more processors;
a user-interactive interface coupled to the one or more processors;
a non-transitory computer readable medium storing instructions executable by the one or more processors to perform operations comprising:
receiving, from the patch of sensors, the stream of data that encode the one or more physical parameters of the contact seal, wherein the one or more physical parameters include the resonant response;
determining, based on at least in part, the resonant response, a current vibrational strain at the contact seal; and
generating, on the user-interactive interface, a rolling display that includes the current vibrational strain.

7. The system of claim 6, wherein the operations further comprise
comparing the current vibrational strain with a plurality of vibrational strain signatures; and
determining whether the current vibrational strain matches at least one of the plurality of vibrational strain signatures that corresponds to a failure condition.

8. The system of claim 7, wherein the operations further comprise:
in response to determining that the current vibrational strain matches at least one of the plurality of vibrational strain signatures that corresponds to a failure condition, generating, on the user-interactive interface, an alert on the user-interactive interface.

9. The system of claim 8, wherein the alert comprises a visual alert, and an audio alert.

10. The system of claim 6, wherein the user-interactive interface is configured to receive user input based on which the one or more processors can adjust the radio frequency signal.

11. The system of claim 1, wherein the rotating seal face and the stationary seal face each comprises an O-ring.

12. A computer-implemented method comprising:
operating an assembly to pump fluid, wherein the assembly comprises a rotating shaft disposed within a central void of the assembly; a gland plate enclosing the central void and surrounding a section of the rotating shaft; and a contact seal wrapped around the rotating shaft and configured to prevent leakage of the fluid being pumped, the contact seal comprising a rotating seal face and a stationary seal face, wherein the rotating seal face is attached to the rotating shaft, and wherein the stationary seal face is mounted on the gland plate;
receiving, from a patch of sensors imbedded in the gland plate, a stream of data encoding one of more physical parameters of the contact seal during operation when the assembly is operating to pump fluid; and
monitoring, based on, at least in part, the stream of data, the contact seal in real-time.

13. The computer-implemented method of claim 12, wherein the patch of sensors are closer to the central void than an outer perimeter of the gland plate.

14. The computer-implemented method of claim 12, wherein the patch of sensors comprise a vibration sensor comprising a polymer substrate, and a resonant layer comprising an electrically conductive nanomaterial and disposed on a surface of the substrate; and
wherein the resonant layer and is configured to generate a resonant response in response to receiving a radio frequency signal from a controller.

15. The computer-implemented method of claim 14, wherein the patch of sensors further comprise a temperature sensor configured to measure an operating temperature of the contact seal.

16. The computer-implemented method of claim 15, further comprising:
receiving, from the patch of sensors, the stream of data that encode the one of more physical parameters of the contact seal, wherein the one or more physical parameters include the resonant response;
determining, based on at least in part, the resonant response, a current vibrational strain at the contact seal; and
generating, on a user-interactive interface, a rolling display that includes the current vibrational strain.

17. The computer-implemented method of claim 16, further comprising:
comparing the current vibrational strain with a plurality of vibrational strain signatures; and
determining whether the current vibrational strain matches at least one of the plurality of vibrational strain signatures that corresponds to a failure condition.

18. The computer-implemented method of claim 17, further comprising:
in response to determining that the current vibrational strain matches at least one of the plurality of vibrational strain signatures that corresponds to a failure condition, generating, on the user-interactive interface, an alert on the user-interactive interface.

19. The computer-implemented method of claim 18, wherein the alert comprises a visual alert, and an audio alert.

20. The computer-implemented method of claim 18, further comprising:
receiving, from the user-interactive interface, user input defining an adjustment to the radio frequency signal; and
executing the adjustment to the radio frequency signal.
